(19) United States
(12) Patent Application Publication
(10) Pub. No.: US 2020/0182723 A1
(43) Pub. Date: Jun. 11, 2020

(54) PRESSURE MEASUREMENT DEVICE AND PRESSURE MEASUREMENT METHOD

(71) Applicant: OMRON HEALTHCARE CO., LTD., Kyoto (JP)

(72) Inventor: Shinya NAKAGAWA, Kyoto (JP)

(21) Appl. No.: 16/791,294

(22) Filed: Feb. 14, 2020

Related U.S. Application Data
(63) Continuation of application No. PCT/JP2018/033770, filed on Sep. 12, 2018.

(30) Foreign Application Priority Data
Sep. 14, 2017 (JP) 2017-177133

(51) Int. Cl. G01L 9/00; G01L 19/06

(52) U.S. Cl. CPC G01L 9/0051; G01L 19/06

(57) ABSTRACT

A pressure measurement device 1 according to the present invention is a device for measuring an internal pressure of a measurement object having an inner space filled with a fluid and a surface layer having a curved surface by a tonometry method. The device includes a pressure sensor 111 including a diaphragm 111A, a pressing part 12 for pressing the pressure sensor against the measurement object, and a control part for performing various calculations and controlling an operation of the device. The control part acquires a displacement value y of the diaphragm in a normal direction on a contact surface of the pressure sensor with the measurement object, and eliminates an influence of tension T acting on the measurement object based on the acquired displacement value.

### CROSS-REFERENCE TO RELATED APPLICATION

The present application is a continuation application of International Application No. PCT/JP2018/033770, filed Sep. 12, 2018, which claims priority to Japanese Patent Application No. 2017-177133, filed Sep. 14, 2017. The contents of these applications are incorporated herein by reference in their entirety.

### BACKGROUND OF THE INVENTION

### (1) Field of the Invention

The present invention relates to a technique for measuring the pressure of an object whose inside is filled with a fluid.

### (2) Description of Related Art

Conventionally, the tonometry method is known as a method for measuring the internal pressure of a measurement object having an internal space filled with fluid, and a blood pressure measurement (that is, blood vessel internal pressure measurement) method using this principle is a well-known technique. Specifically, a pressure sensor is pressed against a blood vessel near the body surface to create a flat portion on the blood vessel wall, which is a curved surface in the natural state, thereby reducing the influence of tension acting on the blood vessel wall. This balances between the internal pressure and the external pressure of the blood vessel and noninvasively measures the blood pressure (see, for example, JP 6-14892).

In order to measure the internal pressure of the measurement object by such a tonometry method, it is necessary to bring a pressure sensor into tight contact with the measurement object so as to form a flat surface in a direction perpendicular to the pressing direction of the pressure sensor instead of simply pressing the pressure sensor against the measurement object. If this is not done, the influence of the tension acting on the measurement object cannot be reduced, and an accurate pressure value cannot be measured.

However, it is not easy to press the pressure sensor against the measurement object so as to form a flat surface suitable for pressure measurement and maintain the state. In many cases, a pressure value cannot be accurately measured due to the shift of the angle defined between the pressing direction of the pressure sensor and the flat surface of the measurement object.

In contrast, there has been proposed a technique of detecting not only a pressure in the pressing direction (z-axis) but also pressures in directions orthogonal to the pressing direction (x-axis and y-axis) by using a X-Y-Z three-axis sensor for the measurement device, correcting an error caused by such a shift, and accurately measuring the pressure value of the measurement object (JP 2011-239840 A). However, the method using such a three-axis sensor has a problem that the apparatus cost increases.

On the other hand, when a general pressure sensor having a strain gauge disposed on one diaphragm is used, even if the pressure sensor is pressed so as to form an appropriate flat surface, a displacement derived from the curved surface of the measurement object microscopically occurs in the diaphragm. In such a portion where the displacement (hereinafter also referred to as strain) due to the curved surface of the measurement object has occurred, the influence of the tension of the measurement object cannot be excluded. In the end, the internal pressure of the measurement object cannot be accurately measured.

### SUMMARY OF THE INVENTION

In view of the situation described above, the present invention aims to provide a technique for measuring an accurate pressure value by eliminating the influence of the tension of a measurement object when performing pressure measurement by a tonometry method using a pressure sensor including a diaphragm.

In order to solve the above problem, a pressure measurement device according to the present invention is a device for measuring an internal pressure of a measurement object having an inner space filled with a fluid and a surface layer having a curved surface by a tonometry method. The device includes a pressure sensor including a diaphragm, a pressing part for pressing the pressure sensor against the measurement object, and a control part for performing various calculations and controlling an operation of the device. The control part acquires a displacement value of the diaphragm in a normal direction on a contact surface of the pressure sensor with the measurement object, and eliminates an influence of tension acting on the measurement object based on the acquired displacement value.

In such a device, in measuring the internal pressure of an object having a fluid in a hollow portion surrounded by a curved surface by a pressure measurement device having a diaphragm, the influence of the tension generated in the strained portion of the diaphragm that cannot be avoided according to the principle of the device can be eliminated, and the accurate internal pressure of the measurement object can be measured. Note that the displacement value of the diaphragm in the normal direction may be calculated based on the output of the pressure sensor, or may be measured using a measurement part different from the pressure sensor.

The pressure measurement device may include a plurality of the pressure sensors whose diaphragms have different elasticities. The control part may acquire displacement values of the diaphragms in the normal direction in the plurality of pressure sensors, and calculate an internal pressure measurement value excluding the influence of the tension acting on the measurement object by using the plurality of acquired displacement values and output values of the pressure sensors when the respective values are acquired.

With such a configuration, it is possible to establish simultaneous equations with the influence of tension and the internal pressure of a measurement object being unknowns by using a plurality of displacement values obtained according to the difference in elasticity between the diaphragms and corresponding output values of the respective pressure sensors when the displacement values are acquired. This makes it possible to eliminate (exclude) the influence of tension and calculate the internal pressure of the measurement object.

The pressing part may press the pressure sensor against the measurement object a plurality of times with different pressing forces. The control part may acquire displacement values of the diaphragm in the normal direction with respect to a plurality of times of pressing with the different pressing forces, and calculate an internal pressure measurement value excluding the influence of the tension acting on the measurement object by using the plurality of acquired displacement values and output values of the pressure sensor when the displacement values are acquired.

In this way, it is possible to provide a device with higher cost performance that can obtain the internal pressure of a measurement object by calculation as described above without increasing the number of pressure sensors.

The pressure sensor may further include a sealed space in which a surface including the diaphragm is a part of a wall, and have a sensor internal pressure acquisition part for acquiring a pressure in the sealed space and a sensor internal pressure adjusting part for increasing and decreasing the pressure in the sealed space. The control part may adjust the pressure in the sealed space so as to make the displacement value of the diaphragm in the normal direction become 0 in a state where the pressure sensor is pressed against the measurement object, and set the value of the pressure in the sealed space in a state where the displacement value is 0 to the value of the internal pressure of the measurement object to eliminate the influence of the tension acting on the measurement object.

When the displacement of the diaphragm in the normal direction becomes 0 as described above in a state where the pressure sensor is pressed against the measurement object so as to form a flat surface, there is no influence of the tension at the contact region of the diaphragm. That is, because the pressure in the sealed space where the displacement value of the diaphragm in the normal direction is 0 balances the internal pressure of the measurement object without the influence of the tension, it is possible to measure the accurate internal pressure of the measurement object upon eliminating the influence of the tension by setting the value of the pressure in the sealed space as the value of the internal pressure of the measurement object.

The sensor internal pressure adjusting part may perform pressurization a plurality of times with different pressures. The control part may acquire displacement values of the diaphragm in the normal direction with respect to a plurality of times of pressurization with the different pressures, and calculate an internal pressure measurement value excluding the influence of the tension acting on the measurement object by using the plurality of acquired displacement values and the value of the pressure in the sealed space when the displacement values are acquired.

In this case, because it is not necessary to completely flatten the diaphragm, complicated and precise pressure control becomes unnecessary, and a device with higher cost performance can be provided.

A pressure measurement method according to the present invention is a method of measuring an internal pressure of a measurement object having an inner space filled with a fluid and a surface layer having a curved surface by a tonometry method using a pressure sensor including a diaphragm. This method includes a strain acquisition step of acquiring a displacement value of the diaphragm in a normal direction at a contact surface where the pressure sensor is pressed against the measurement object and a tension component exclusion step of excluding an influence of tension acting on the measurement object based on the displacement value of the diaphragm in the normal direction acquired in the strain acquisition step.

According to such a method, in measuring the internal pressure of an object having a fluid in a hollow portion surrounded by a curved surface by a pressure sensor having a diaphragm, the influence of the tension caused in the strained portion of the diaphragm can be eliminated, and the accurate internal pressure of the measurement object can be measured.

The strain acquisition step may include acquiring a plurality of displacement values of the diaphragm in the normal direction. The tension component exclusion step may include calculating an internal pressure measurement value excluding the influence of the tension acting on the measurement object by using the plurality of acquired displacement values acquired in the strain acquisition step and output values of the pressure sensors when the displacement values are acquired.

With such a method, it is possible to establish simultaneous equations with the influence of tension and the internal pressure of a measurement object being unknowns by using a plurality of values concerning the obtained displacement of the diaphragms and corresponding output values of the respective pressure sensors when the displacement values are acquired. This makes it possible to eliminate (exclude) the influence of tension and calculate the internal pressure of the measurement object

The strain acquisition step may include acquiring the displacement values of a plurality of regions of the measurement object by a plurality of pressure sensors with diaphragms having different elasticities.

The strain acquisition step may include acquiring a displacement value of the diaphragm in the normal direction a plurality of times in accordance with different pressing forces by pressing the pressure sensor against the measurement object a plurality of times with different pressing forces.

The pressure sensor may further internally include a sealed space in which a surface including the diaphragm is a part of a wall. The tension component exclusion step may include internally pressurizing the sealed space so as to make the displacement value of the diaphragm in the normal direction become 0 in a state where the pressure sensor is pressed against the measurement object, and setting the value of the pressure in the sealed space after the pressurization to an internal pressure of the measurement object to eliminate the influence of the tension acting on the measurement object.

The pressure sensor may further internally include a sealed space in which a surface including the diaphragm is a part of a wall. The strain acquisition step may include acquiring a displacement value of the diaphragm in the normal direction a plurality of times in accordance with different pressures by controlling the sealed space a plurality of times with different pressures in a state where the pressure sensor is pressed against the measurement object.

### ADVANTAGEOUS EFFECTS OF INVENTION

The present invention can provide a technique for measuring an accurate pressure value by eliminating the influence of the tension of a measurement object when performing pressure measurement by a tonometry method using a pressure sensor including a diaphragm.

### BRIEF DESCRIPTION OF THE DRAWINGS

FIG. 1 is a block diagram showing an overall configuration of a pressure measurement device according to a first embodiment;

FIG. 2 is a schematic view showing a state in which the measurement unit of the pressure measurement device according to the first embodiment is attached to a measurement object;

FIG. 3 is a cross-sectional view schematically showing the structure of the measurement unit of the pressure measurement device according to the first embodiment and a state at the time of measurement;

FIG. 4 is a view showing a surface, of the sensor unit of the pressure measurement device according to the first embodiment, which comes into contact with a measurement object;

FIG. 5 is a block diagram showing an outline of the functional configuration of the control unit of the pressure measurement device according to the first embodiment;

FIG. 6 is a flowchart showing an example of a procedure of processing performed by the pressure measurement device according to the first embodiment;

FIG. 7 is a schematic cross-sectional view for explaining the state of a contact portion when the pressure measurement device is pressed against a measurement object;

FIG. 8A is a schematic cross-sectional view showing the states of a first pressure sensor and a measurement object when the measurement unit of the pressure measurement device according to the first embodiment is pressed against the measurement object;

FIG. 8B is a schematic cross-sectional view showing the states of a second pressure sensor and the measurement object when the measurement unit of the pressure measurement device according to the first embodiment is pressed against the measurement object;

FIG. 9 is a block diagram showing the functional configuration of a pressure measurement device according to a modification of the first embodiment;

FIG. 10 is a flowchart showing a procedure of internal pressure measurement processing performed by a pressure measurement device according to a modification of the first embodiment;

FIG. 11 is a schematic cross-sectional view showing the configuration of the sensor unit of a pressure measurement device according to the second embodiment;

FIG. 12 is a flowchart showing a procedure of internal pressure measurement processing performed by a pressure measurement device according to the second embodiment;

FIG. 13 is a block diagram showing the functional configuration of a pressure measurement device according to a modification of the second embodiment; and

FIG. 14 is a flowchart showing a procedure of internal pressure measurement processing performed by a pressure measurement device according to the modification of the second embodiment.

### DETAILED DESCRIPTION OF PREFERRED EMBODIMENTS

A mode for carrying out the present invention will be exemplarily described based on embodiments with reference to the accompanying drawings. However, the dimensions, materials, shapes, relative arrangements, and the like of the components described in this embodiment are not intended to limit the scope of the present invention only to those unless otherwise specified.

### First Embodiment

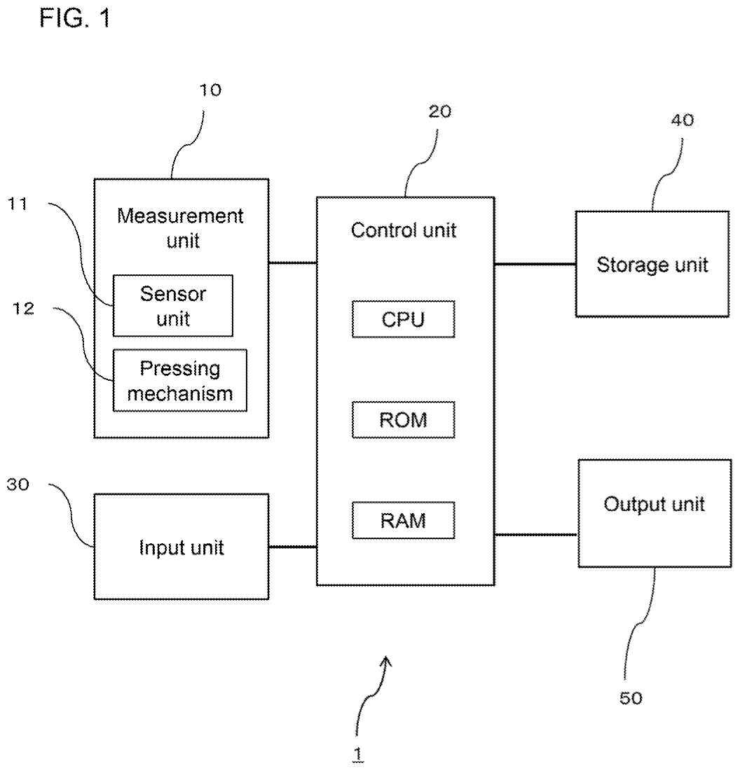

The first embodiment of the present invention will be described with reference to FIGS. 1 to 8. The pressure measurement device according to this embodiment is a device that can measure the internal pressure of an object having a fluid in an internal space surrounded by a curved surface by a tonometry method. In this case, the tonometry method is a method of measuring the internal pressure of a measurement object by pressing the surface of the measurement object with an appropriate pressure to form a flat portion so as to suppress the influence of the tension acting on the surface of the measurement object, and balancing between the internal pressure and external pressure of the measurement object at the flat portion.

### Configuration of Pressure Measurement Device

FIG. 1 is a block diagram showing the overall configuration of a pressure measurement device 1 according to this embodiment. The pressure measurement device 1 generally includes a measurement unit 10, a control unit 20, an input unit 30, a storage unit 40, and an output unit 50. The pressure measurement device 1 may be a stationary device that is used by placing a measurement object on a fixed base during measurement or a portable device that is used by being attached to a measurement object.

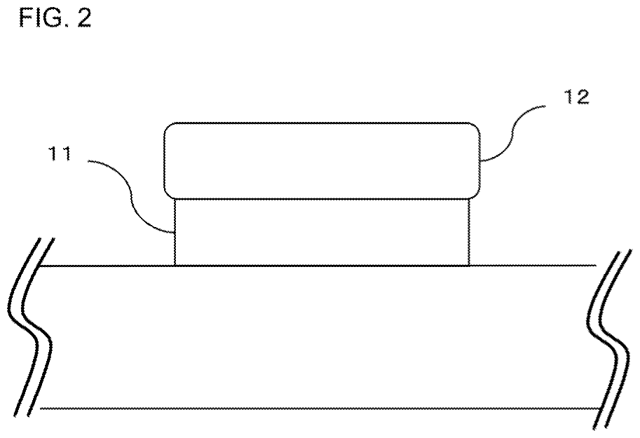

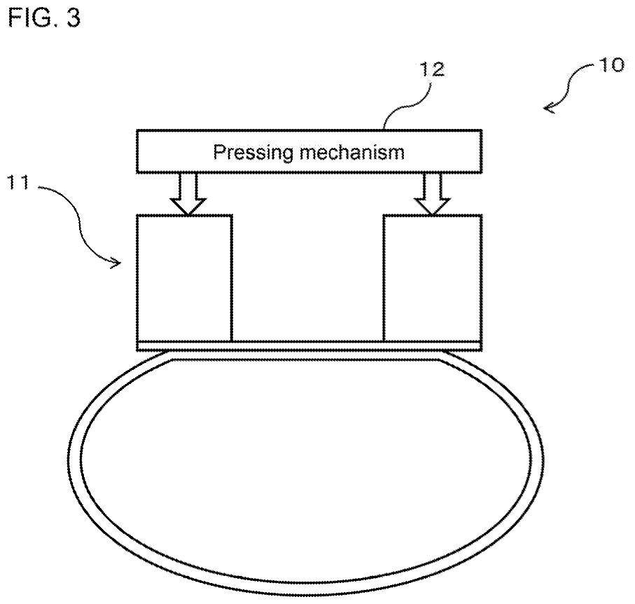

The measurement unit 10 measures the internal pressure of the measurement object using a sensor unit 11. FIG. 2 is a schematic view showing a state in which the measurement unit 10 is attached to a measurement object (for example, a water supply hose), and FIG. 3 is a cross-sectional view schematically showing the structure of the measurement unit 10 and a state at the time of measurement. As shown in FIGS. 2 and 3, the measurement unit 10 includes the sensor unit 11 and a pressing mechanism 12 for pressing the sensor unit 11 against a measurement object, and the sensor unit 11 is disposed in contact with the surface layer of the measurement object.

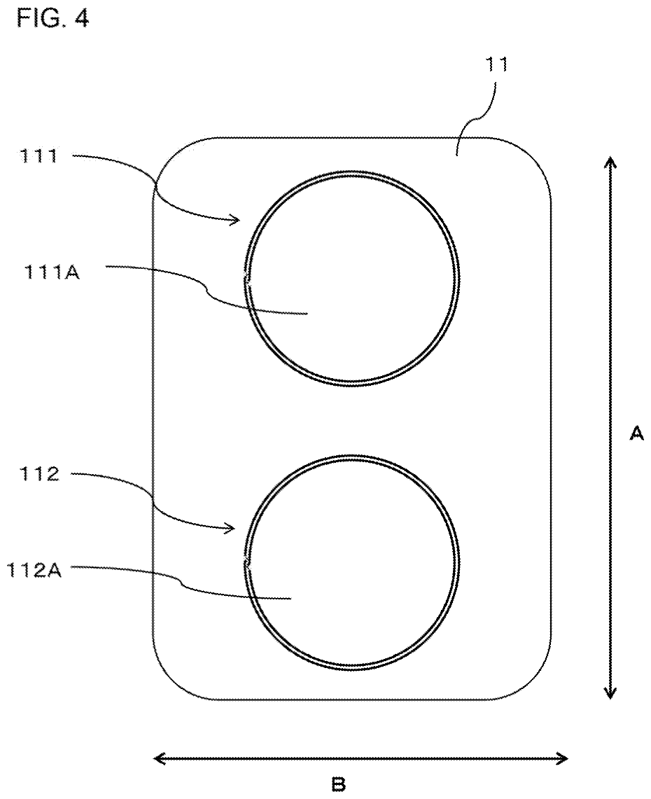

FIG. 4 is a view showing the surface, of the sensor unit 11, which comes into contact with the measurement object. As shown in FIG. 4, the sensor unit 11 has a first pressure sensor 111 and a second pressure sensor 112 arranged side by side, and the measurement unit 10 is attached to the measurement object such that an arrangement direction A of the sensors coincides with the longitudinal direction of the measurement object.

Each of the first and second pressure sensors includes a circular diaphragm and a pressure-sensitive element formed on the diaphragm. Each pressure sensor detects a change in electric resistance caused when the pressure-sensitive element is distorted through the diaphragm that receives pressure. That is, when displacement (distortion) occurs in the diaphragm, the displacement can be measured.

A diaphragm (to be referred to as the first diaphragm hereinafter) 111A of the first pressure sensor 111 and a diaphragm (to be referred to as the second diaphragm hereinafter) 112A of the second pressure sensor have different thicknesses. The first diaphragm 111A is thinner than the second diaphragm 112A. That is, the first diaphragm 111A has a smaller elastic modulus than the second diaphragm 112A. When the first diaphragm 111A is pressed against the measurement object with the same pressing force, the first diaphragm 111A is displaced more greatly. In this embodiment, the diaphragms have different thicknesses. However, any configuration in which each diaphragm has a different elastic modulus may be used. For example, different materials may be used for the respective diaphragms to make them have different elastic moduli.

The pressing mechanism 12 includes, for example, an air bag and a pump that adjusts the internal pressure of the air bag. When the control unit 20 controls the pump to increase the internal pressure of the air bag, each pressure sensor is pressed against the surface of the measurement object due to the expansion of the air bag. The pressing mechanism 12 may be anything that can adjust the pressing force, and is not limited to one using an air bag.

The control unit 20 performs various processes such as control of each unit of the pressure measurement device 1, recording/analysis of measured data, and input/output of data. The control unit 20 includes a processor, a read only memory (ROM), a random access memory (RAM), and the like. The function of the control unit 20 to be described later is implemented by making the processor read and execute programs stored in the ROM or the storage unit 40. The RAM functions as a work memory when the control unit 20 performs various processes.

The input unit 30 provides an operation interface for the user. For example, operation buttons, switches, a touch panel, and the like can be used.

The storage unit 40 is a storage medium that can store and read data, and stores programs executed by the control unit 20, measurement data obtained from the measurement unit 10, and various data obtained by processing the measurement data. As the storage unit 40, for example, a flash memory is used. The storage unit 40 may be a portable type such as a memory card or may be built in the pressure measurement device 1.

The output unit 50 provides an interface for outputting information to the user. For example, a liquid crystal display, a loudspeaker, and the like can be used. In addition, a display device other than a liquid crystal display, an audio output device other than a loudspeaker, a communication device that performs data communication with other devices, and the like can be used. The data communication method in the communication device may be wired or wireless. Moreover, it is also possible to use them in combination.

### Function of Control Unit

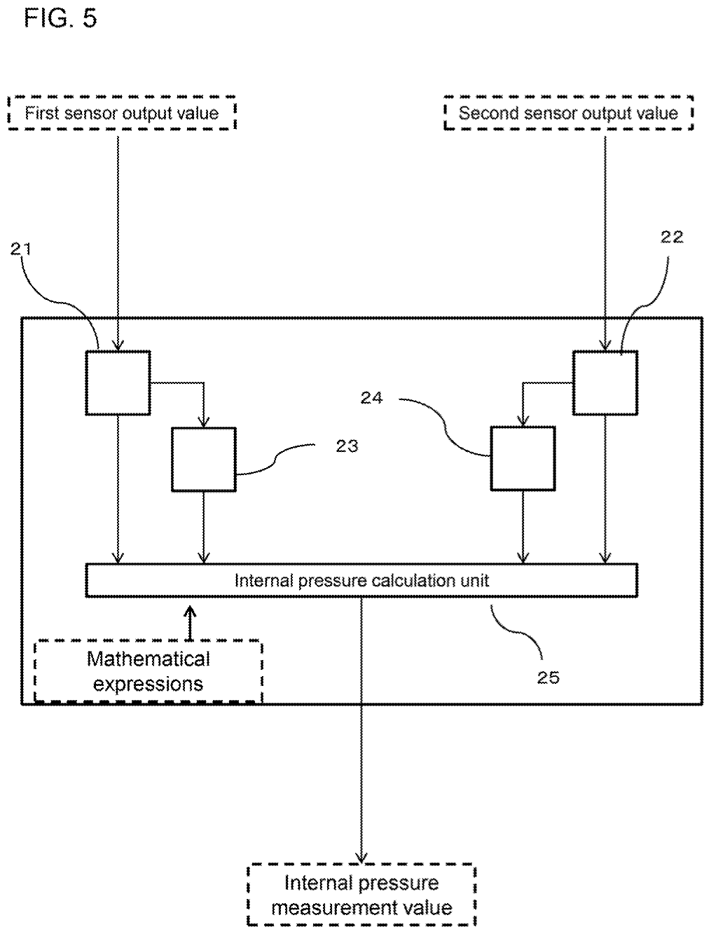

FIG. 5 is a block diagram showing an outline of the functional configuration of the control unit 20. As shown in FIG. 5, the control unit 20 has, as basic functions, a first sensor output value holding unit 21, a second sensor output value holding unit 22, a first diaphragm displacement value acquisition unit 23, and a second diaphragm displacement value acquisition unit 24, and internal pressure calculation unit 25. In this embodiment, the functions of these units are implemented by making the control unit 20 execute necessary programs.

The first sensor output value holding unit 21 is a function of holding a pressure value output as an electric signal from the pressure-sensitive element of the first pressure sensor 111, and the second sensor output value holding unit 22 is a function of holding a pressure value output as an electrical signal from the pressure sensitive element of the second pressure sensor 112.

The first diaphragm displacement value acquisition unit 23 is a function of acquiring the displacement value of the first diaphragm 111A due to the sensor unit 11 being pressed against the measurement object. Likewise, the second diaphragm displacement value acquisition unit 24 is a function of acquiring the displacement value of the second diaphragm 112A. In this embodiment, as will be described later, the displacement values of the diaphragms are calculated based on the output values of the first pressure sensor 111 and the second pressure sensor 112, respectively.

As will be described later, the internal pressure calculation unit 25 is a function of calculating an internal pressure while eliminating the influence of the tension of the measurement object by predetermined calculation expressions, based on the values obtained from the first sensor output value holding unit 21, the second sensor output value holding unit 22, the first diaphragm displacement value acquisition unit 23, and the second diaphragm displacement value acquisition unit 24.

### Processing for Internal Pressure Measurement

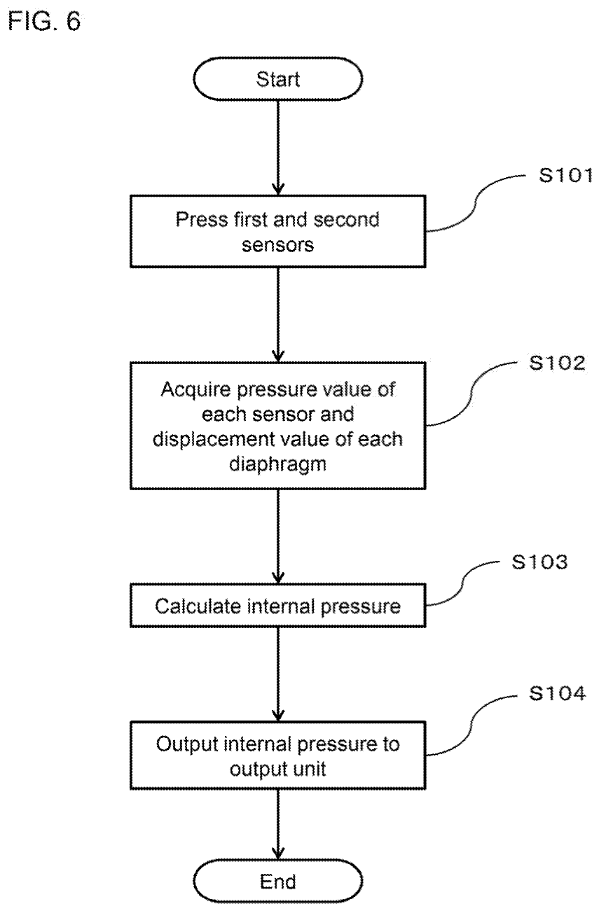

Processing for measuring the internal pressure of a measurement object in the pressure measurement device 1 according to this embodiment will be described next. FIG. 6 is a flowchart showing an example of a procedure of processing performed by the pressure measurement device 1 according to this embodiment. As shown in FIG. 6, first of all, the control unit 20 controls the pressing mechanism 12 of the measurement unit 10 to press the sensor unit 11 against the measurement object so as to form a flat portion on the surface layer of the measurement object, and maintain the pressing force in an appropriate state (step S101). The control unit 20 then obtains output values from the first pressure sensor 111 and the second pressure sensor 112 of the sensor unit 11 and the displacement values of the first diaphragm 111A and the second diaphragm 112A (step S102). Subsequently, the control unit 20 measures an internal pressure by calculating a value excluding the influence of the tension using the values obtained in step S102 and predetermined mathematical expressions (step S103). The predetermined mathematical expressions are stored in advance in the ROM or the storage unit 40. The calculated value is then output to the output unit 50 (for example, a liquid crystal display) (step S104).

### Predetermined Mathematical Expressions

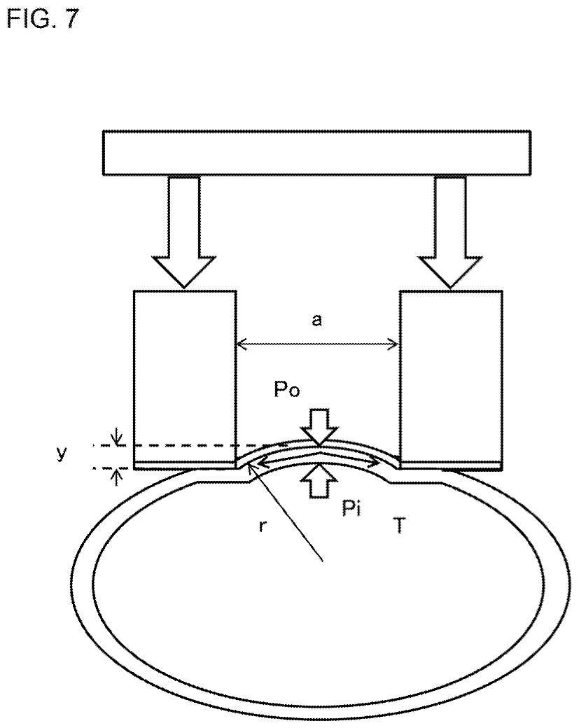

As described above, the control unit 20 performs the processing of calculating the internal pressure of the measurement object based on predetermined mathematical expressions. The predetermined mathematical expressions will be described. FIG. 7 is a schematic cross-sectional view showing a state in which a pressure sensor including a circular diaphragm having a diameter a is pressed against a measurement object with an internal pressure Pi. In FIG. 7, Po represents the external pressure acting on the measurement object, y represents the displacement of the diaphragm in the normal direction, T represents the tension acting on the surface layer of the measurement object, and r represents the radius of the arc displacement of the diaphragm. As shown in FIG. 7, the diaphragm pressed against the measurement object does not become completely flat but is distorted and displaced in an arc shape, and the force obtained by adding an influence T/r due to the tension of the measurement object to the internal pressure Pi balances the external pressure Po. That is, the external pressure Po does not accurately represent the internal pressure Pi, and the following relational expression (1) holds.

$$\begin{matrix}[ Mathematic expression 1 ] & \\ Po = Pi + \frac{T}{r} & ( 1 )\end{matrix}$$

In this case, the mathematical expression for obtaining r from y and a is mathematical expression (2) given below.

$$\begin{matrix}[ Mathematic expression 2 ] & \\ r = \frac{{a}^{2}}{8 y} + \frac{y}{2} & ( 2 )\end{matrix}$$

Therefore, from mathematical expressions (1) and (2), the internal pressure Pi of the measurement object can be obtained by mathematical expression (3) given below.

$$\begin{matrix}[ Mathematic expression 3 ] & \\ Pi = Po - T \cdot \frac{8 y}{{a}^{2} + 4 {y}^{2}} & ( 3 )\end{matrix}$$

Because Po and y have the relationship represented by mathematical expression (4) given below, the displacement y of the diaphragm in the normal direction can be obtained from the value of the external pressure Po, a Poisson's ratio v of the diaphragm, and a Young's modulus (elasticity) E of the diaphragm, a thickness t of the diaphragm, and the diameter a of the diaphragm. In this embodiment, in this way, the displacement of the diaphragm is obtained from the respective constants described above and the output value (i.e., Po) of the sensor. Because the constants v, E, t, and a are determined for each diaphragm mounted on the sensor, they may be registered in advance in a storage unit or the like.

$$\begin{matrix}[ Mathematic expression 4 ] & \\ y = 3 \cdot \frac{1 - {v}^{2}}{E \cdot {t}^{3}} \cdot {a}^{4} \cdot Po & ( 4 )\end{matrix}$$

As described above, when the tension of the measurement object is clear, the internal pressure Pi can be accurately obtained by mathematical expression (3), but when the value of the tension T is an inconstant, the internal pressure Pi cannot be accurately obtained. If the arc displacement of the diaphragm can be completely flattened, r will be infinite and the value of T/r will be 0. Setting Pi=Po can eliminate the influence of the tension and accurately obtain the internal pressure Pi. However, such setting cannot be used in consideration of the structure of the sensor using the diaphragm.

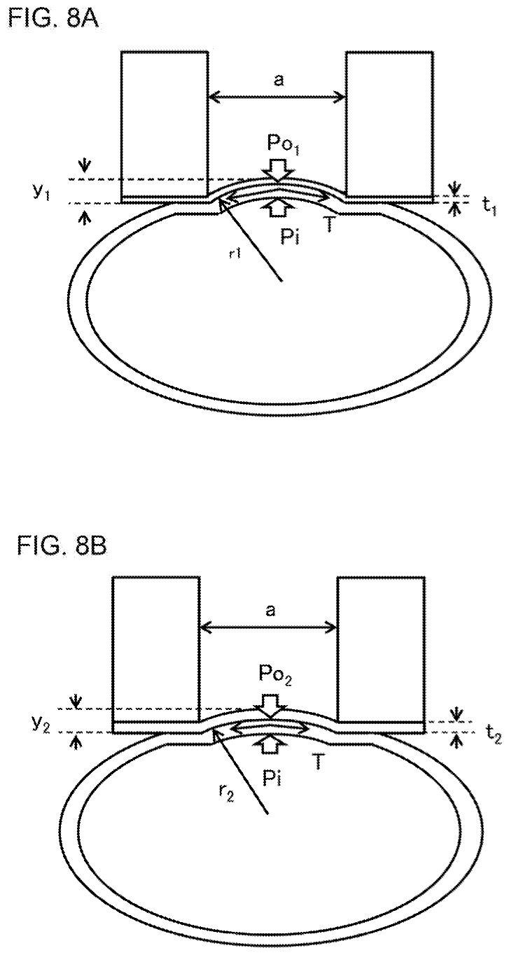

Accordingly, by using another sensor having a different diaphragm elasticity, two values are obtained from the same measurement object, thereby eliminating the influence of T and calculating the internal pressure Pi of the measurement object. FIGS. 8A and 8B are schematic cross-sectional views showing the states of each sensor and the measurement object when the measurement unit 10 is pressed against the measurement object. FIG. 8A shows the states of the first pressure sensor 111 and the measurement object. FIG. 8B shows the states of the second pressure sensor 112 and the measurement object. As described above, the first diaphragm 111A and the second diaphragm 112A have different thicknesses, and the displacements of the respective diaphragms in the normal direction differ in magnitude, as shown in FIGS. 8A and 8B. In FIGS. 8A and 8B, t1 represents the thickness of the first diaphragm 111A, t2 represents the thickness of the second diaphragm 112A, y1 represents the displacement of the first diaphragm 111A, and y2 represents the displacement of the second diaphragm 112A.

In this case, in the state shown in FIGS. 8A and 8B, mathematical expressions (5) and (6) are obtained.

$$\begin{matrix}[ Mathematic expression 5 ] & \\ Pi = {Po}_{1} - T \cdot \frac{8 {y}_{1}}{{a}^{2} + 4 {y}_{1}^{2}} & ( 5 ) \\ [ Mathematic expression 6 ] & \\ Pi = {Po}_{2} - T \cdot \frac{8 {y}_{2}}{{a}^{2} + 4 {y}_{2}^{2}} & ( 6 )\end{matrix}$$

Mathematical expressions (5) and (6) yield mathematical expressions (7) given below which obtains the internal pressure Pi by eliminating the influence of the tension T.

$$\begin{matrix}[ Mathematic expression 7 ] & \\ ( Pi - {Po}_{1} ) \frac{{a}^{2} + 4 {y}_{1}^{2}}{8 {y}_{1}} = ( Pi - {Po}_{2} ) \frac{{a}^{2} + 4 {y}_{2 }^{2}}{8 {y}_{2}} \\ Pi ( \frac{{a}^{2} + 4 {y}_{1}^{2}}{8 {y}_{1}} - \frac{{a}^{2} + 4 {y}_{2}^{2}}{8 {y}_{2}} ) = {Po}_{1} \frac{{a}^{2} + 4 {y}_{1}^{2}}{8 {y}_{1}} - {Po}_{2} \frac{{a}^{2} + 4 {y}_{2}^{2}}{8 {y}_{2}} \\ Pi = \frac{{Po}_{1} \cdot {y}_{2} ( {a}^{2} + 4 {y}_{1}^{2} ) - {Po}_{2} \cdot {y}_{1} ( {a}^{2} + 4 {y}_{2}^{2} )}{{y}_{2} ( {a}^{2} + 4 {y}_{1}^{2} ) - {y}_{1} ( {a}^{2} + 4 {y}_{2}^{2} )} & ( 7 )\end{matrix}$$

That is, the control unit 20 calculates the internal pressure Pi of the measurement object by using mathematical expression (7) held in advance, the values of the outputs (that is, Po₁ and Po₂) of the first pressure sensor 111 and the second pressure sensor 112), and the respective displacements (i.e., y₁ and y₂) of the first diaphragm 111A and the second diaphragm 112A.

The above arrangement of the pressure measurement device 1 makes it possible to measure an accurate pressure value by eliminating the influence of the tension of a measurement object when performing pressure measurement by a tonometry method using a pressure sensor including a diaphragm.

### Modification 1 of First Embodiment

In the pressure measurement device 1 according to the first embodiment, the sensor unit 11 includes two sensors having different diaphragm elasticities. However, the pressure measurement device 1 may be configured to include only one sensor unit 11. In that case, the functional configuration and the procedure of processing for internal pressure measurement are as follows.

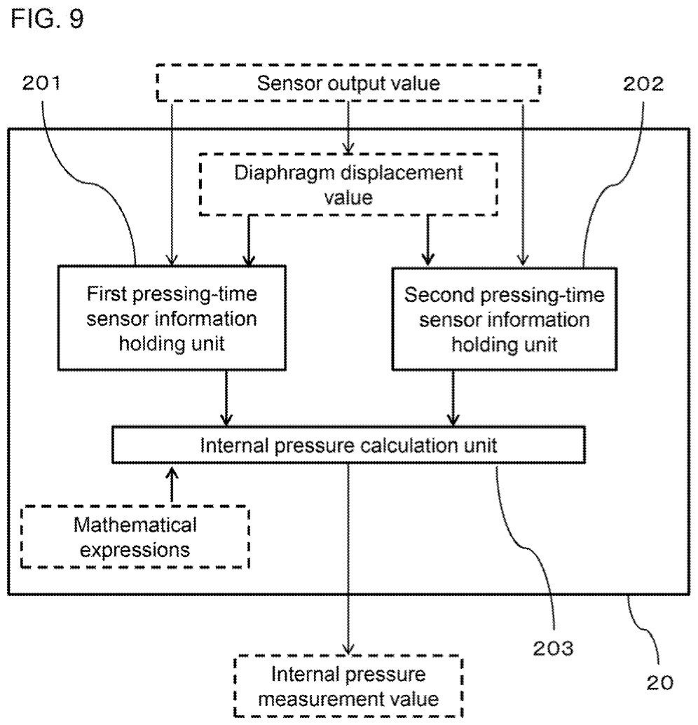

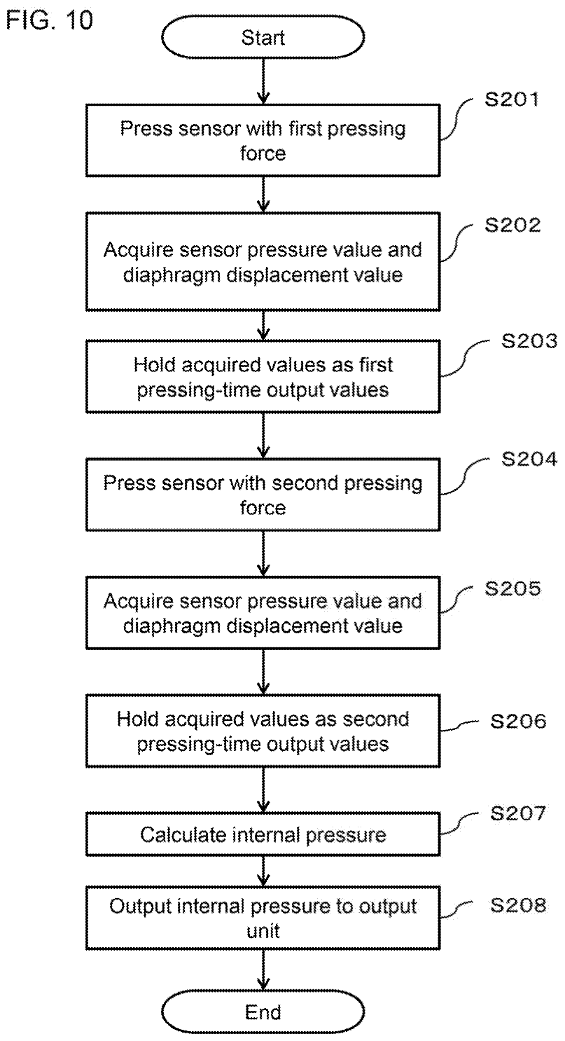

FIG. 9 is a block diagram showing the functional configuration of the pressure measurement device 1 according to a modification. FIG. 10 is a flowchart showing a procedure of internal pressure measurement processing by the pressure measurement device 1 according to the modification. As shown in FIG. 9, the control unit 20 of the pressure measurement device 1 according to this modification includes, as basic functions, a first pressing-time sensor information holding unit 201, a second pressing-time sensor information holding unit 202, and an internal pressure calculation unit 203. In addition, the configuration of the device other than the number of sensors of the sensor unit 11 and the function of the control unit 20 is basically the same as that of the first embodiment.

As shown in FIG. 10, the control unit 20 according to this modification controls the pressing mechanism 12 of the measurement unit 10, presses the sensor unit 11 against the measurement object with a first pressing force, and maintains the state (step S201). The control unit 20 acquires an output value of the sensor unit 11 and the displacement value of the diaphragm (step S202), and holds them in the first pressing-time sensor information holding unit 201 (step S203).

Subsequently, the control unit 20 controls the pressing mechanism 12 of the measurement unit 10 again, to press the sensor unit 11 against the measurement object with a second pressing force, and maintains the state (step S204). The control unit 20 acquires an output value of the sensor unit 11 and the displacement value of the diaphragm (step S205), and holds them in the second pressing-time sensor information holding unit 202 (step S206).

In this way, even if a single pressure sensor is used, it is possible to obtain a plurality of values of the sensor output (i.e., Po) and the diaphragm displacement (i.e., y) with respect to the same measurement object by sequentially changing the pressing force that presses the sensor against the measurement object. In this case, it is only necessary to be able to obtain different sensor output values and corresponding diaphragm displacement values. For example, in step S201 and step S204, the pressing mechanism may be controlled to obtain the first displacement value and the second displacement value instead of setting the first pressing force and the second pressing force as numerical values.

The internal pressure is measured by calculating a value excluding the influence of the tension using the values held in the first pressing-time sensor information holding unit 201 and the second pressing-time sensor information holding unit 202 and mathematical expressions (7) given above (step S207). The calculated value is output to the output unit 50 (step S208).

As described above, by configuring the pressure measurement device 1 as in this modification, the number of sensors mounted on the device can be reduced to one, contributing to downsizing and cost reduction of the device.

### Modification 2 of First Embodiment

The pressure measurement device 1 may be configured to include a tension calculation unit as a function of the control unit 20 so as to measure the tension of the measurement object. The tension calculation unit is a function of calculating the tension of the measurement object using a predetermined mathematical expression.

For example, the tension T of the measurement object can be obtained by mathematical expression (8) obtained from mathematical expressions (5) and (6) based on a plurality of sensor output values and a plurality of diaphragm displacement values.

$$\begin{matrix}[ Mathematic expression 8 ] & \\ T = \frac{{Po}_{2} - {Po}_{1}}{\frac{8 {y}_{2}}{{a}^{2} + 4 {y}_{2}^{2}} - \frac{8 {y}_{1}}{{a}^{2} + 4 {y}_{1}^{2}}} & ( 8 )\end{matrix}$$

Once the internal pressure Pi₁ at a certain time point is obtained, T can also be obtained from mathematical expression (9) obtained from mathematical expression (5) based on the value of the internal pressure Pi₁.

$$\begin{matrix}[ Mathematic expression 9 ] & \\ T = \frac{( {a}^{2} + 4 {y}_{1}^{2} ) ( {Po}_{1} - {Pi}_{1} )}{8 {y}_{1}} & ( 9 )\end{matrix}$$

Once the value of the tension T of the measurement object is obtained by mathematical expression (8) or (9) given above, the internal pressure of the measurement object is accurately measured by substituting the value into mathematical expression (3) given above. That is, if one sensor output value and one diaphragm displacement value are obtained, the internal pressure can be accurately measured based on the values. Even if one sensor is provided as in Modification 1 described above, it is possible to continuously measure the internal pressure of the measurement object.

### Second Embodiment

Another embodiment of the present invention will be described next. This embodiment differs from the first embodiment in the structure of a sensor unit 11 and differs in the way of obtaining the internal pressure excluding the influence of the tension of the measurement object. However, the devices according to these embodiments have many common components as a whole. Therefore, the same reference numerals denote such common components, and a detailed description of them will be omitted.

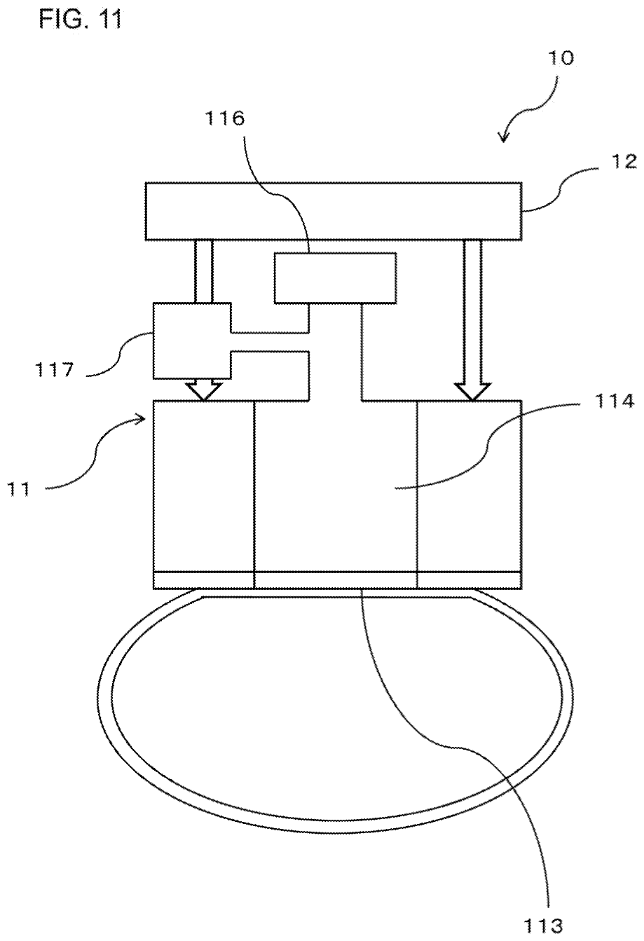

FIG. 11 is a schematic cross-sectional view showing the configuration of a measurement unit 10 of a pressure measurement device according to this embodiment. The sensor unit 11 includes a circular diaphragm 113 and a pressure-sensitive element formed on the diaphragm, and further has an internal sealed space (hereinafter referred to as a chamber) 114 in which the diaphragm 113 is a part of a wall. The measurement unit 10 further includes a chamber internal pressure sensor 116 for measuring the pressure in the chamber 114 and a chamber internal pressure adjusting pump (to be referred to as a pump hereinafter) 117 for adjusting the internal pressure by increasing and decreasing the pressure in the chamber 114. In this embodiment, the chamber internal pressure sensor 116 corresponds to the sensor internal pressure measuring part, and the pump 117 corresponds to the sensor internal pressure adjusting part.

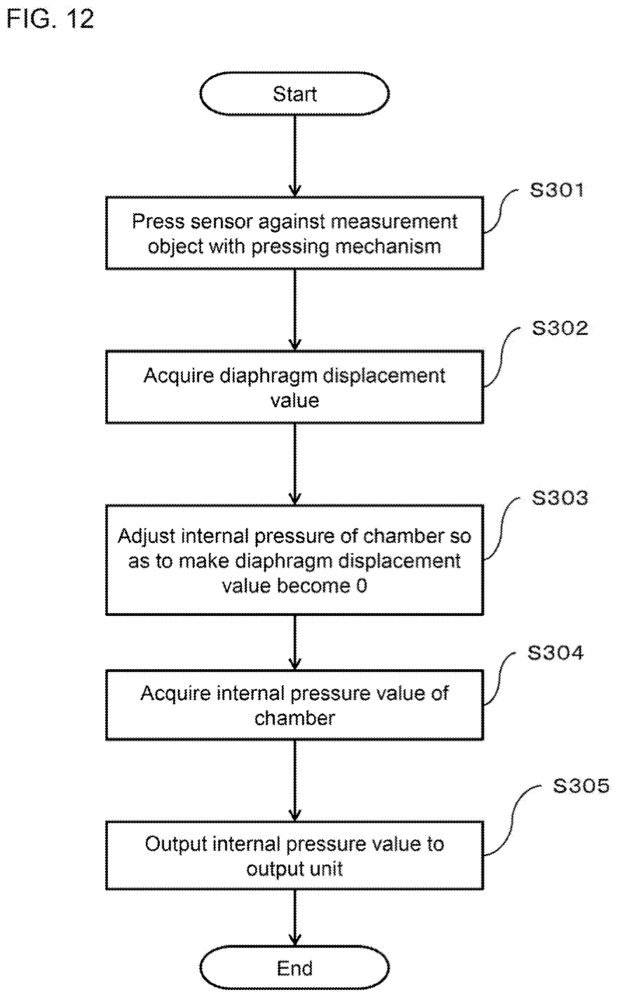

A procedure of processing for internal pressure measurement in this embodiment will be described next. FIG. 12 is a flowchart showing a procedure of internal pressure measurement processing performed by the pressure measurement device according to this embodiment. As shown in FIG. 12, first of all, a control unit 20 of the pressure measurement device according to this embodiment controls a pressing mechanism 12 of the measurement unit 10 to press the sensor unit 11 against the measurement object so as to form a flat portion on the surface layer of the measurement object and maintain the state (step S301). In this state, the control unit 20 measures the displacement value of the diaphragm 113 in the normal direction (step S302), and controls the pump 117 so as to set the value to 0 (step S303). The output value of the chamber internal pressure sensor 116 in this state is obtained (step S304), and is output to an output unit 50 (step S305).

As described above, when pressed against the measurement object, the diaphragm 113 is distorted in an arc shape, and is displaced in the normal direction with respect to the measurement object. In this case, by increasing the internal pressure of the chamber 114, the diaphragm 113 is pushed back to a completely flat state (that is, the displacement value of the diaphragm in the normal direction is set to 0). This perfectly balances between the internal pressure of the measurement object and the pressure in the chamber 114 without the influence of the tension.

As described above, by setting the output value of the chamber internal pressure sensor 116 to the internal pressure of the measurement object, it is possible to eliminate the influence of the tension of the measurement object and to measure an accurate internal pressure value.

### Modification 1 of Second Embodiment

The second embodiment has exemplified the method of measuring an accurate internal pressure value while eliminating the influence of the tension of the measurement object by increasing the internal pressure of the chamber 114 to push back the diaphragm 113 so as to set the diaphragm in a completely flat state. However, it is also possible to eliminate the influence of the tension of the measurement object without making the diaphragm 113 completely flat. In that case, the functional configuration and the procedure of processing for internal pressure measurement are as follows.

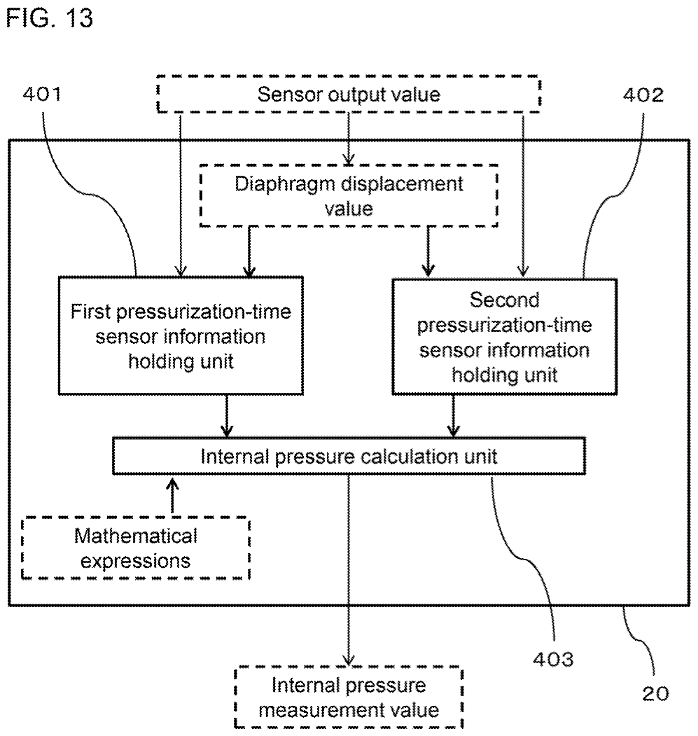

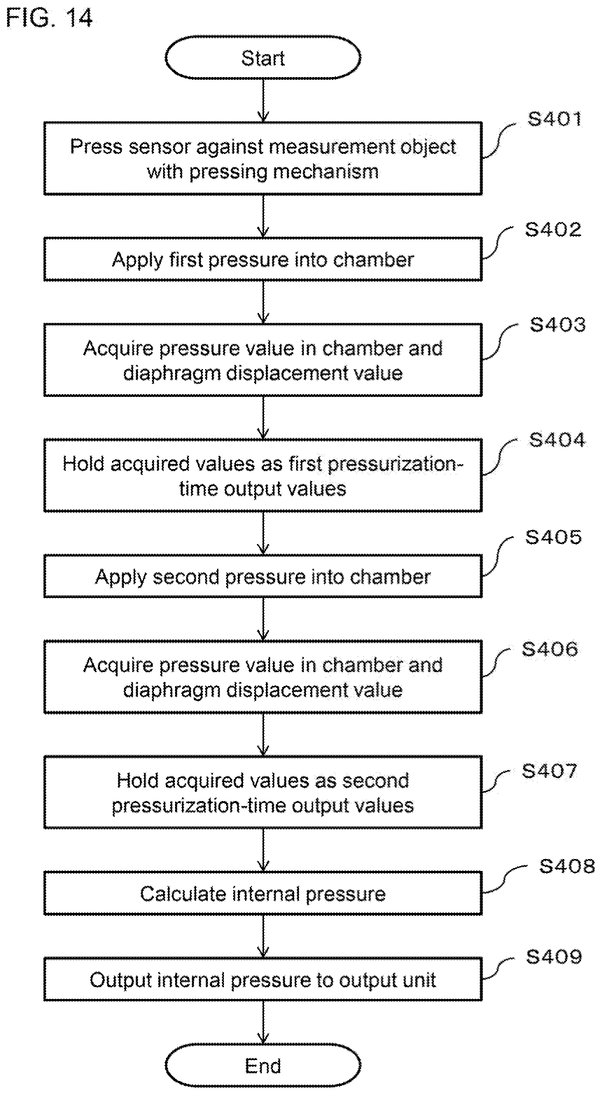

FIG. 13 is a block diagram showing the functional configuration of the pressure measurement device 1 according to a modification of the second embodiment. FIG. 14 is a flowchart showing a procedure of internal pressure measurement processing by the pressure measurement device 1 according to this modification. As shown in FIG. 13, the control unit 20 of the pressure measurement device 1 according to this modification includes, as basic functions, a first pressurization-time sensor information holding unit 401, a second pressurization-time sensor information holding unit 402, and an internal pressure calculation unit 403. The overall configuration of the device is basically the same as that of the second embodiment.

As shown in FIG. 14, first of all, the control unit 20 according to this embodiment controls the pressing mechanism 12 of the measurement unit 10 to press the sensor unit 11 against the measurement object (step S401). The control unit 20 then controls the pump 117 in this state to apply a first pressure to the chamber and maintains the state (step S402). The control unit 20 acquires an output value of the sensor unit 11 and the displacement value of the diaphragm 113 (step S403), and holds them in the first pressurization-time sensor information holding unit 401 (step S404).

Subsequently, the control unit 20 controls the pump 117 to apply a second pressure into the chamber 114, and maintains this state (step S405). The control unit 20 acquires an output value of the sensor unit 11 and the displacement value of the diaphragm 113 (step S406), and holds them in the second pressurization-time sensor information holding unit 402 (step S407).

Thus, even if the diaphragm 113 is not completely flattened, by sequentially changing the pressure applied in the chamber 114, a plurality of values of the chamber internal pressure and the diaphragm displacement are obtained for the same measurement object. In this case, it is only necessary to be able to obtain different chamber internal pressures and corresponding diaphragm displacement values. For example, in step S402 and step S405, the pump 117 may be controlled to obtain the first displacement value and the second displacement value instead of setting the first pressurizing force and the second pressurizing force as numerical values.

The internal pressure is measured by calculating a value excluding the influence of the tension using the values held in the first pressurization-time sensor information holding unit 401 and the second pressurization-time sensor information holding unit 402 and mathematical expression (10) given below (step S408). The calculated value is output to the output unit 50 (step S409).

$$\begin{matrix}[ Mathematic expression 10 ] & \\ Pi = {Pc}_{1} - {y}_{1} \cdot \frac{{Pc}_{1} - {Pc}_{2}}{{y}_{1} - {y}_{2}} & ( 10 )\end{matrix}$$

In mathematical expression (10) given above, Pc₁ is the chamber internal pressure at the first pressurization, Pc₂ is the chamber internal pressure at the second pressurization, y₁ is the displacement of the diaphragm at the first pressurization, and y₂ is the displacement of the diaphragm 113 at the second pressurization.

By measuring the internal pressure by the method described above, it is possible to measure the internal pressure of the object without completely flattening the diaphragm 113. This eliminates the necessity to perform complicated and precise pressure control for making the diaphragm 113 completely flat, and hence can suppress an increase in the cost of the device.

### Modification 2 of Second Embodiment

The functional configuration of the device may be a configuration including a tension calculation unit as a function of the control unit 20. The tension calculation unit is a function of calculating the tension of the measurement object using a predetermined mathematical expression. In the second embodiment, the tension T may be obtained from mathematical expression (9) given above and the value of the internal pressure obtained temporarily.

In this case, when the chamber 114 is opened to the atmosphere with the sensor unit 11 being pressed against the measurement object after internal pressure measurement, the sensor output value (Po) and the displacement value (y) of the diaphragm 113 can be obtained continuously. Because the diameter a is a fixed value, the internal pressure of the measurement object can be accurately measured by substituting them and the value of the tension T obtained above into mathematical expression (3) given above. Further, because the internal pressure can be continuously measured based on Po and y obtained continuously, the internal pressure of the measurement object can be continuously measured.

### Others

Each of the above embodiments is merely exemplary of the present invention, and the present invention is not limited to the specific forms described above. The present invention can be variously modified and combined within the scope of the technical idea. For example, a plurality of sensors of the sensor unit 11 may be provided in an array in a direction B in FIG. 4. In this way, even when the pressure measurement device 1 cannot be attached to a measurement object itself, for example, when the measurement object is a radial artery, using a sensor value indicating the best measurement result makes it possible to stably perform measurement.

The pressure sensor may be formed by micro electro mechanical systems (MEMS). In this case, the pressure sensor may be formed integrally with a part or all of the control unit 20. Further, a plurality of pressure sensors may be formed on one chip. With such a configuration, the overall device can be reduced in size and be applied to a small measurement object.

The pressure sensor may be formed of a pressure sensitive film. This makes it possible to improve the adhesiveness to a measurement object will improve and increase the accuracy of measurement. Moreover, if the measurement object is a living organ, the wearability of the device is improved, and the discomfort can be reduced.

The above embodiments are configured to output measurement results to the output unit. However, in addition to this configuration, the embodiments may be configured to store and accumulate measurement values in the storage unit. Further, the output unit is not necessarily required, and the embodiments may be configured to only record measurement values in the storage unit

The application range of the present invention is wide, and the measurement object is not limited to the water supply hose exemplified in the above embodiments. For example, the present invention can be applied to, for example, living organs such as blood vessels and various types of cushions such as air mats and water beds.

What is claimed is:

1. A pressure measurement device for measuring an internal pressure of a measurement object having an inner space filled with a fluid and a surface layer having an elastically deformable curved surface by a tonometry method, the pressure measurement device comprising:
a pressure sensor including a diaphragm;
a pressing part for pressing the pressure sensor against the measurement object; and
a control part for performing various calculations and controlling an operation of the device,
wherein the control part acquires a displacement value of the diaphragm in a normal direction on a contact surface of the pressure sensor with the measurement object when the diaphragm has displaced in a state where the pressure sensor is pressed against the measurement object so as to form a flat portion on the surface layer of the measurement object, and eliminates an influence of tension acting on the measurement object, based on the acquired displacement value.

2. The pressure measurement device according to claim 1, further comprising a plurality of the pressure sensors whose diaphragms have different elasticities,
wherein the control part acquires displacement values of the diaphragms in the normal direction in the plurality of pressure sensors, and calculates an internal pressure measurement value excluding the influence of the tension acting on the measurement object by using the plurality of acquired displacement values and output values of the pressure sensors when the displacement values are acquired.

3. The pressure measurement device according to claim 1, wherein
the pressing part presses the pressure sensor against the measurement object a plurality of times with different pressing forces, and
the control part acquires displacement values of the diaphragm in the normal direction with respect to a plurality of times of pressing with the different pressing forces, and calculates an internal pressure measurement value excluding the influence of the tension acting on the measurement object by using the plurality of acquired displacement values and output values of the pressure sensor when the displacement values are acquired.

4. The pressure measurement device according to claim 1, wherein
the pressure sensor further includes a sealed space in which a surface including the diaphragm is a part of a wall, and has a sensor internal pressure acquisition part for acquiring a pressure in the sealed space, and a sensor internal pressure adjusting part for increasing and decreasing the pressure in the sealed space, and
the control part adjusts the pressure in the sealed space so as to make the displacement value of the diaphragm in the normal direction become 0 in a state where the pressure sensor is pressed against the measurement object, and sets the value of the pressure in the sealed space in a state where the displacement value is 0 to the value of the internal pressure of the measurement object to eliminate the influence of the tension acting on the measurement object.

5. The pressure measurement device according to claim 1, wherein
the pressure sensor further includes a sealed space in which a surface including the diaphragm is a part of a wall, and has a sensor internal pressure acquisition part for acquiring a pressure in the sealed space, and a sensor internal pressure adjusting part for increasing and decreasing the pressure in the sealed space, and
the sensor internal pressure adjusting part applies an internal pressure a plurality of times with different pressures in a state where the pressure sensor is pressed against the measurement object, and the control part acquires displacement values of the diaphragm in the normal direction with respect to a plurality of times of pressure application with the different pressures, and calculates an internal pressure measurement value excluding the influence of the tension acting on the measurement object by using the plurality of acquired displacement values and the value of the pressure in the sealed space when the displacement values are acquired.

6. A pressure measurement method of measuring an internal pressure of a measurement object having an inner space filled with a fluid and a surface layer having an elastically deformable curved surface by a tonometry method using a pressure sensor including a diaphragm, the method comprising:
a strain acquisition step of acquiring a displacement value of the diaphragm in a normal direction at a contact surface where the pressure sensor is pressed against the measurement object when the diaphragm has displaced in a state where the pressure sensor is pressed against the measurement object so as to form a flat portion on the surface layer of the measurement object; and
a tension component exclusion step of excluding an influence of tension acting on the measurement object, based on the displacement value of the diaphragm in the normal direction acquired in the strain acquisition step.

7. The pressure measurement method according to claim 6, wherein
the strain acquisition step includes acquiring a plurality of displacement values of the diaphragm in the normal direction, and
the tension component exclusion step includes calculating an internal pressure measurement value excluding the influence of the tension acting on the measurement object by using the plurality of acquired displacement values acquired in the strain acquisition step and output values of the pressure sensor when the displacement values are acquired.

8. The pressure measurement method according to claim 6, wherein the strain acquisition step includes acquiring the displacement values by a plurality of pressure sensors with diaphragms having different elasticities.

9. The pressure measurement method according to claim 6, wherein the strain acquisition step includes acquiring a displacement value of the diaphragm in the normal direction a plurality of times in accordance with different pressing forces by pressing the pressure sensor against the measurement object a plurality of times with different pressing forces.

10. The pressure measurement method according to claim 6, wherein
the pressure sensor further internally includes a sealed space in which a surface including the diaphragm is a part of a wall, and
the tension component exclusion step includes internally pressurizing the sealed space so as to make the displacement value of the diaphragm in the normal direction become 0 in a state where the pressure sensor is pressed against the measurement object, and setting the value of the pressure in the sealed space after the pressurization to an internal pressure of the measurement object to eliminate the influence of the tension acting on the measurement object.

11. The pressure measurement method according to claim 6, wherein
the pressure sensor further internally includes a sealed space in which a surface including the diaphragm is a part of a wall, and
the strain acquisition step includes acquiring a displacement value of the diaphragm in the normal direction a plurality of times in accordance with different internal pressures by internally pressurizing the sealed space a plurality of times with different pressures in a state where the pressure sensor is pressed against the measurement object.
